(19) United States
(12) Patent Application Publication
(10) Pub. No.: US 2018/0370466 A1
(43) Pub. Date: Dec. 27, 2018

(54) ELECTRICITY SUPPLY RELAY CIRCUIT, SUB-BATTERY MODULE, AND POWER SOURCE SYSTEM

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Hayaki MURATA, Yokkaichi-shi (JP); Shinya ITOU, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/064,776

(22) PCT Filed: Dec. 27, 2016
(86) PCT No.: PCT/JP2016/088825

§ 371 Date: Jun. 21, 2018

(30) Foreign Application Priority Data
Jan. 7, 2016 (JP) 2016-001695

(51) Int. Cl. B60R 16/033; B60L 11/18; B60R 21/017; E05F 15/695; H02J 9/06; G05B 9/02

(52) U.S. Cl. CPC B60R 16/033; B60L 11/1851; B60R 21/017; E05F 15/695; B60R 2021/0016; G05B 9/02; E05Y 2800/428; E05Y 2400/10; H02J 9/06

(57) ABSTRACT

An electricity supply relay circuit for relaying electricity supplied from a sub-battery to a plurality of loads to which electricity is supplied from a main battery provided in a vehicle, the electricity supply relay circuit including: a plurality of switches corresponding to the loads; an electricity receiving wire connecting the switches to the sub-battery; a plurality of electricity supply wires corresponding to the loads via which electricity is supplied from the switches to the corresponding loads; and a control circuit that turns on the switches when a voltage of the main battery is lower than a predetermined first threshold.

### TECHNICAL FIELD

The present invention relates to a technique of supplying electricity to a load.

### BACKGROUND ART

When vehicles fall into a port or fall from a viaduct, for example, and are submerged in water, there are cases where doors cannot be opened due to water pressure. In such a situation, it is desirable that the driver can escape through a window. Power windows need to work in order to open/close the windows, and therefore, even when vehicles are submerged in water, it is necessary to ensure that electricity is supplied to the power windows. For example, Patent Document 1 discloses a technique of allowing the power windows to work normally even when a vehicle is submerged in water.

### CITATION LIST

### Patent Document

Patent Document 1: JP H11-22300A

### SUMMARY OF INVENTION

### Technical Problem

However, with the technique disclosed in Patent Document 1, the power windows cannot work normally when a vehicle-mounted power source is submerged in water and has short-circuited, and the vehicle-mounted power source thus fails.

To address this, it is an object of the present invention to provide a technique of supplying electricity to an electrical load in a vehicle even in a case where one of the vehicle-mounted power sources fails.

### Solution to Problem

An electricity supply relay circuit relays electricity supplied from a sub-battery to a plurality of loads to which electricity is supplied from a main battery provided in a vehicle. The electricity supply relay circuit includes a plurality of switches corresponding to the loads, an electricity receiving wire connecting the switches to the sub-battery, a plurality of electricity supply wires corresponding to the loads via which electricity is supplied from the switches to the corresponding loads, and a control circuit that turns on the switches when the voltage of the main battery is lower than a predetermined first threshold.

### Advantageous Effects of Invention

Electricity is supplied to an electrical load in a vehicle even in a case where one of the vehicle-mounted power sources fails.

### BRIEF DESCRIPTION OF DRAWINGS

FIG. 1 is a block diagram showing an electricity supply relay circuit according to an embodiment and the surrounding region.

FIG. 2 is a flowchart illustrating a procedure for controlling turning-on/turning-off of switches.

FIG. 3 is a schematic view showing an example of the arrangement of a main battery and a sub-battery module in a vehicle.

FIG. 4 is a circuit diagram showing an example of the configuration of a relay that realizes a switch.

FIG. 5 is a block diagram showing a modified configuration.

### DESCRIPTION OF EMBODIMENTS

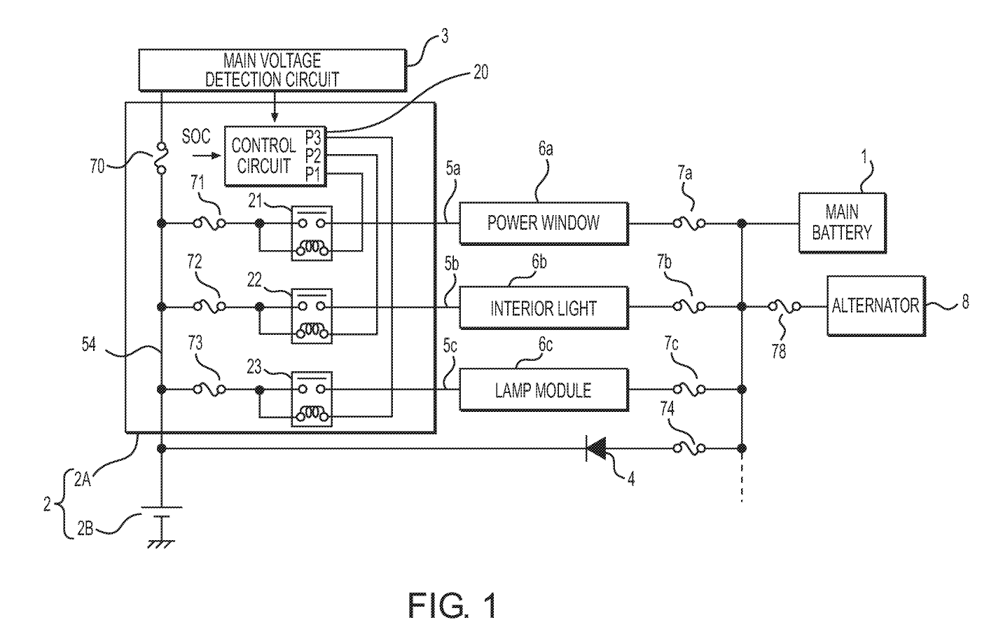

FIG. 1 is a block diagram showing an electricity supply relay circuit 2A according to this embodiment and the surrounding region.

A plurality of loads, namely loads 6a, 6b, and 6c, are all electrical loads in a vehicle, and electricity is supplied from a main battery 1 mounted in a vehicle (that is, a vehicle-mounted main battery 1) to these loads 6a, 6b, and 6c via fuses 7a, 7b, and 7c. The electricity supply relay circuit 2A relays electricity supplied from a sub-battery 2B to the loads 6a, 6b, and 6c. The main battery 1 is a 12-V battery to which a lead storage battery is applied, for example. The sub-battery 2B may be a lithium-ion battery or an electric double layer capacitor, for example. An alternator 8 is connected to the fuses 7a, 7b, and 7c and the main battery 1 via a fuse 78. The alternator 8 exhibits a power generation function while the vehicle is traveling, and charges the main battery 1. Alternatively, the alternator 8 charges the sub-battery 2B with regenerated power via a diode 4, which will be described later.

The electricity supply relay circuit 2A includes switches 21, 22, and 23 and electricity supply wires 5a, 5b, and 5c. The switches 21, 22, and 23 correspond to the loads 6a, 6b, and 6c, respectively. The electricity supply wires 5a, 5b, and 5c correspond to the loads 6a, 6b, and 6c, respectively, and electricity is supplied from the respective switches 21, 22, and 23 to the corresponding loads 6a, 6b, and 6c via the electricity supply wires 5a, 5b, and 5c. The electricity supply relay circuit 2A further includes an electricity receiving wire 54 and a control circuit 20. The electricity receiving wire 54 connects the switches 21, 22, and 23 to the sub-battery 2B. Fuses 71, 72 and 73 may be respectively provided between the electricity receiving wire 54 and the switches 21, 22, and 23.

More specifically, the load 6a is connected to the electricity receiving wire 54 via the switch 21 (and additionally the fuse 71), the load 6b is connected to the electricity receiving wire 54 via the switch 22 (and additionally the fuse 72), and the load 6c is connected to the electricity receiving wire 54 via the switch 23 (and additionally the fuse 73).

Electricity is supplied from the sub-battery 2 to a main voltage detection circuit (e.g., a voltage sensor for a 12-V battery) 3 via the electricity receiving wire 54, and the main voltage detection circuit 3 detects the voltage of the main battery 1. Since a known technique is used for such detection, detailed description thereof is omitted, but it is clear that the main voltage detection circuit 3 advantageously works even when the main battery 1 fails. For example, a fuse 70 is provided between the electricity receiving wire 54 and the main voltage detection circuit 3. The control circuit 20 compares the voltage of the main battery 1 detected by the main voltage detection circuit 3 with a predetermined first threshold, determines that the main battery 1 is submerged in water when the voltage of the main battery is lower than the first threshold, and establishes electrical conduction in the switches 21, 22, and 23. As described above, the first threshold used to determine that the main battery 1 is submerged in water can be stored in the control circuit 20, for example.

The sub-battery 2B can be charged with the main battery 1 via the fuse 74, or with the alternator 8 via the fuses 78 and 74. Accordingly, the sub-battery 2B acts as a backup power source for the main battery 1.

It should be noted that the diode 4 that allows the sub-battery 2B to be charged with the main battery 1 or the alternator 8 and prevents discharging of the sub-battery 2B to the main battery 1 or the alternator 8 is provided between the sub-battery 2B and the fuse 74. Accordingly, even when the power generation function of the alternator 8 deteriorates or the voltage of the main battery 1 decreases (and furthermore, the main battery 1 fails), discharging of the sub-battery 2B that is caused thereby is avoided.

The sub-battery 2B and the electricity supply relay circuit 2A can be considered as a sub-battery module 2 that supplies electricity to the loads 6a, 6b, and 6c when the voltage of the main battery 1 decreases or the main battery 1 fails. Both the sub-battery module 2 and the main battery 1 can supply electricity to the loads 6a, 6b, and 6c. The sub-battery module 2 and the main battery 1 can be considered as a power source system for supplying a power source to the load 6a, 6b, and 6c.

The loads 6a, 6b, and 6c are a power window, an interior light, and a lamp module, respectively, for example. In order to allow a driver to escape through the window, the priority order of these loads for electricity supply is set such that the priority decreases in the order of the power window, the interior light, and the lamp module. The reason for this is that it is also desirable to turn on hazard lights in a case of submergence in water in order to act as a beacon to nearby emergency crew, but the interior light used to check the situation inside the vehicle and the power window used for escape are of higher priority, and the power window is of a higher priority than the interior light.

When the switches 21, 22, and 23 are turned on and the sub-battery 2B supplies electricity, the charging amount of the sub-battery 2B decreases, and therefore, it is desirable that the switches 21, 22, and 23 are turned off based on the above-mentioned priority order. Specifically, it is desirable to introduce a predetermined second threshold Sb for the load 6b, which is an interior light, and a predetermined second threshold Sc for the load 6c, which is a lamp module, Sb being set to be smaller than Sc, and compare these thresholds with the state of charge (referred to as “SOC” hereinafter) of the sub-battery 2B. Specifically, when the SOC is smaller than the second threshold Sc, the switch 23 is turned off to stop supplying electricity to the load 6c, and when the SOC is smaller than the second threshold Sb, the switch is turned off to stop supplying electricity to the load 6b. Since the above-mentioned priority order is determined in advance, the second thresholds Sb and Sc can be stored in the control circuit 20, for example.

Accordingly, even when the charging amount of the sub-battery 2B is consumed due to submergence of the main battery 1, the sub-battery 2B can preferentially supply electricity to a load that is very much needed (i.e., of a high priority) for a driver to be able to escape through the window. It is the control circuit 20 that detects SOC and turns off the switches 22 and 23 based on the detected SOC. A known technique is used to obtain the SOC, and the detailed description thereof is omitted herein.

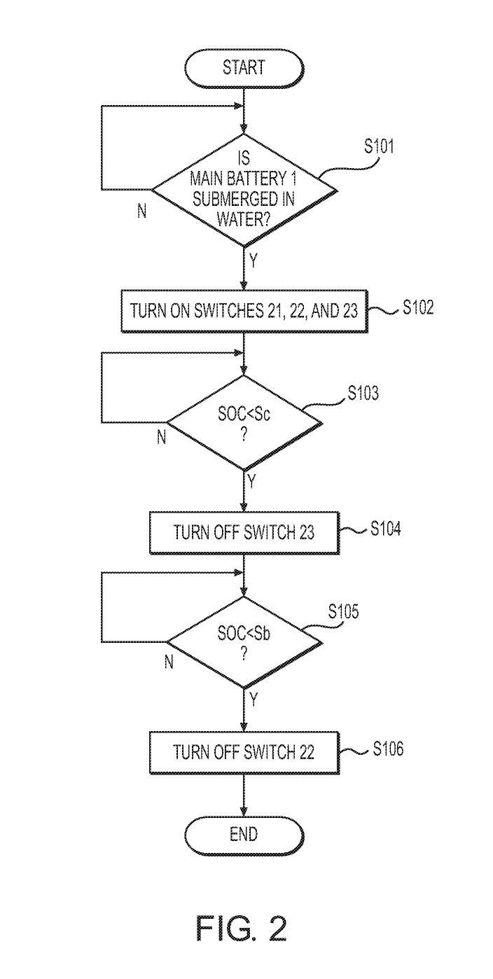

FIG. 2 is a flowchart illustrating a procedure for controlling turning-on/turning-off of the switches 21, 22, and 23, and the control circuit 20 executes this procedure. In step S101, it is determined whether or not the main battery 1 is submerged in water. As described above, this determination can be made based on the voltage of the main battery 1 detected by the main voltage detection circuit 3.

When the determination made in step S101 is negative, that is, when it is determined that the main battery 1 is not submerged in water (or when it is not determined that the main battery 1 is submerged in water), step S101 is repeated. When the determination made in step S101 is positive, that is, when it is determined that the main battery 1 is submerged in water, the switches 21, 22, and 23 are turned on in step S102. As a result, the sub-battery 2B starts to supply electricity to the loads 6a, 6b, and 6c.

Thereafter, in step S103, it is determined whether or not the SOC of the sub-battery 2B is smaller than the second threshold Sc. When the determination made in step S103 is negative, that is, when it is determined that the SOC of the sub-battery 2B is larger than or equal to the second threshold Sc, step S103 is repeated. When the determination made in step S103 is positive, that is, when the SOC of the sub-battery 2B is smaller than the second threshold Sc, the switch 23 is turned off in step S104. As a result, when the SOC of the sub-battery 2B decreases, the supply of electricity to the load 6c (the lamp module in the above-described embodiment), which is of the lowest priority among the load 6a, 6b, and 6c, is stopped.

Thereafter, in step S105, it is determined whether or not the SOC of the sub-battery 2B is smaller than the second threshold Sb (which is smaller than Sc). When the determination made in step S105 is negative, that is, when it is determined that the SOC of the sub-battery 2B is larger than or equal to the second threshold Sb, step S105 is repeated. When the determination made in step S105 is positive, that is, when the SOC of the sub-battery 2B is smaller than the second threshold Sb, the switch 22 is turned off in step S106. As a result, when the SOC of the sub-battery 2B further decreases, the supply of electricity to the load 6b (the interior light in the above-described embodiment), which is of a lower priority than the load 6a, is stopped.

After step S106 is executed, this procedure is finished without turning off the load 6a (the power window in the above-described embodiment) since the load 6a is of the highest priority.

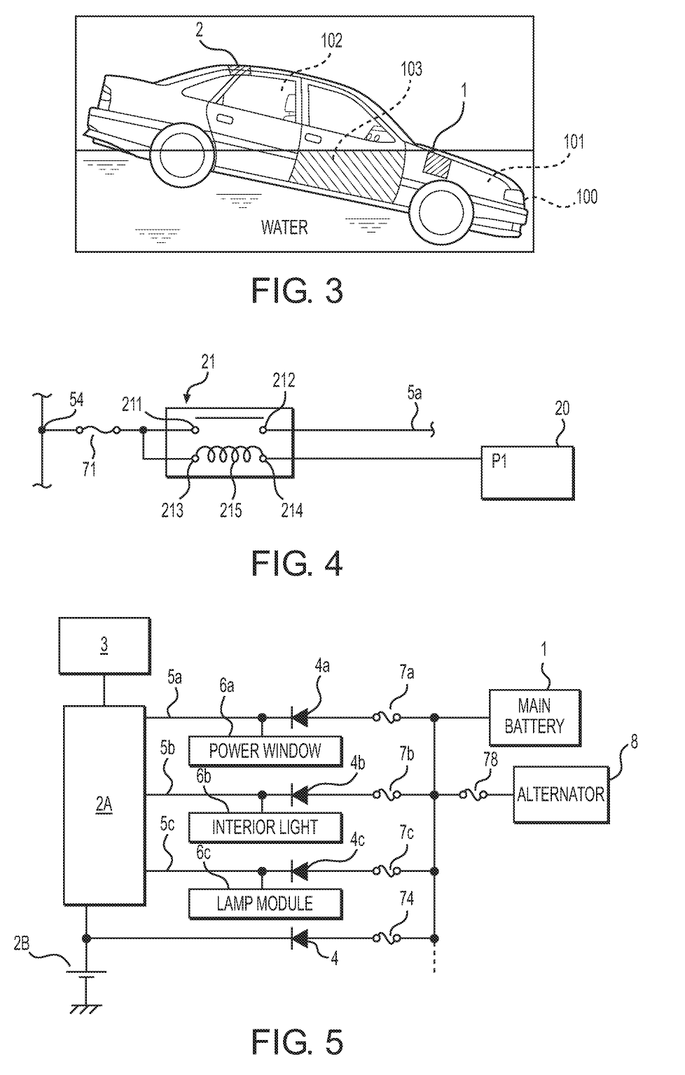

FIG. 3 is a schematic view showing an example of the arrangement of the main battery 1 and the sub-battery module 2 in a vehicle 100. The vehicle 100 includes an engine room 101 and a cabin 102. The alternator 8 is usually provided in the engine room 101, and therefore, the main battery 1 is also provided in the engine room 101 in order to reduce the electrical resistance of a charging path to the main battery 1 (it will be appreciated that the main battery 1 can also be provided in a portion other than the engine room 101). As illustrated in FIG. 3 as an example, when the vehicle 100 is submerged in water, the cabin 102 is submerged in water later than the engine room 101 due to the weight of or vacant space in the cabin 102. In FIG. 3, a case where the engine room 101 is located on the front side of the vehicle 100 is shown as an example, but the engine room 101 may also be located on the rear side of the vehicle 100. When the vehicle 100 is submerged in water, it is difficult to open a door 103 due to water pressure (see the hatched region in FIG. 3).

It is desirable that the electricity supply relay circuit 2A, the sub-battery 2B, and the main voltage detection circuit 3 are provided at positions diagonally opposite to the main battery 1 in the vehicle 100 such that the sub-battery module 2 works in such a situation. In FIG. 3, a case where the main battery 1 is provided in the engine room 101 and the sub-battery module 2 is provided in a roof of the cabin 102 is shown as an example. Considering that the sub-battery 2B is a lithium-ion battery or an electric double layer capacitor as described above, for example, it is not especially difficult to provide the sub-battery module 2 in the roof of the cabin 102.

Accordingly, even when the engine room 101 is submerged in water and the main battery 1 thus fails, electricity can be supplied to the loads 6a, 6b, and 6c in the vehicle 100 as long as the cabin 102 is not submerged in water.

The switches 21, 22, and 23 each can be realized using a relay. FIG. 4 is a circuit diagram showing an example of the configuration of the relay when the switch 21 is taken as an example. A relay used in the switch 21 includes a first terminal 211, a second terminal 212, a third terminal 213, a fourth terminal 214, and a relay coil 215. The first terminal 211 is connected to the electricity receiving wire 54 (via the fuse 71 in a case where the fuse 71 is provided), and the second terminal 212 is connected to the electricity supply wire 5a. The third terminal 213 is connected to the first terminal 211, and the fourth terminal 214 is connected to a control terminal P1 of the control circuit 20. The relay coil 215 functions as an electric conduction control element, and electric conduction between the first terminal 211 and the second terminal 212 is allowed as a result of an electric current flowing through the relay coil 215. That is, the relay shown as an example herein is of a normally open type.

The control circuit 20 controls the electric potential of the control terminal P1, specifically, sets the electric potential of the control terminal P1 to be lower than the electric potential of the sub-battery 2B inside the control circuit 20, and thus allows an electric current to flow through the relay coil 215, and electric conduction between the first terminal 211 and the second terminal 212 is thus allowed. As a result, the switch 21 is turned on.

The same configuration is also applied to the switches 22 and 23. The control circuit 20 controls the electric potentials of the control terminals P2 and P3, specifically, sets the electric potentials of the control terminals P2 and P3 to be lower than the electric potential of the sub-battery 2B, and electric conduction in the switches 22 and 23 is thus allowed.

The control circuit 20 may also detect the electric potentials of the control terminals P1, P2, and P3. If the fuses 71, 72, and 73 have not melted, the voltage of the sub-battery 2B will be applied to the control terminal P1 via the switches 21, 22, and 23. If the fuse 71 has melted, the control terminal P1 will be in a floating state, and therefore, the voltage will not be applied thereto. The same applies to the fuses 72 and 73. This makes it possible to detect whether or not the fuses 71, 72, and 73 have melted.

### Modified Example

FIG. 5 is a block diagram showing a modified configuration of the above-mentioned embodiment in which electricity can be supplied from both the main battery 1 and the sub-battery module 2 to loads 6a, 6b, and 6c that each include only one electricity supply port.

A diode 4a is provided in series with a fuse 7a between the electricity supply wire 5a and the main battery 1. It should be noted that the diode 4a is provided extending in such a direction that charging of the main battery 1 with the sub-battery module 2 is prevented. In general, the supply of electricity from the main battery 1 to the load 6a is realized by an electric current flowing from the main battery 1 toward the load 6a. Therefore, in FIG. 5, the diode 4a is connected such that its cathode is located on the electricity supply wire 5a side and its anode is located on the main battery 1 side. For example, in the example shown in the diagram, the cathode of the diode 4a is connected to both the electricity supply wire 5a and the load 6a, and the anode is connected to the main battery 1 via the fuse 7a. Alternatively, one end of the fuse 7a may be connected to both the electricity supply wire 5a and the load 6a, and the other end may be connected to the main battery 1 via the diode 4a.

With this configuration, an electric current does not flow from the sub-battery module 2 to the main battery 1, and therefore, when the main battery 1 fails due to a short circuit, a function of supplying electricity from the sub-battery module 2 to the load 6a is less likely to be prevented. On the other hand, if the main battery 1 does not fail, electricity can be supplied from the main battery 1 to the load 6a, and furthermore, the control circuit 20 can lower the electric potential of the control terminal P1 to turn on the switch 21 and to charge the sub-battery 2b with the alternator 8 or the main battery 1 via the fuse 71, the electricity supply wire 5a, and the diode 4a (see FIG. 1).

Similarly to the diode 4a, a diode 4b is provided between the electricity supply wire 5b and the main battery 1, and a diode 4c is provided between the electricity supply wire 5c and the main battery 1. Therefore, when the main battery 1 fails due to a short circuit, a function of supplying electricity from the sub-battery module 2 to the loads 6b and 6c is less likely to be prevented. In addition, if the main battery 1 does not fail due to a short circuit, electricity can be supplied from the main battery 1 to the loads 6b and 6c, and furthermore, electric conduction is established in at least one of the switches 21, 22, and 23, thus making it possible to charge the sub-battery 2B with the alternator 8 or the main battery 1.

A submergence sensor for detecting the submergence of the main battery 1 can also be used instead of the main voltage detection circuit 3 to make a determination in step S101. Alternatively, an electric current sensor for detecting an electric current flowing through the fuses 7a, 7b, and 7c can also be used instead of the main voltage detection circuit 3 to make the determination in step S101. It should be noted that it can be determined whether or not the fuses 7a, 7b, and 7c have melted by determining whether or not the loads 6a, 6b, and 6c work properly.

The above-mentioned various modifications can be used in combination as appropriate as long as their functions are not mutually inhibited.

Having described the present invention in detail, the foregoing description is illustrative in all aspects and the present invention is not limited thereto. It is understood that countless modified examples not illustrated herein are conceivable without deviating from the scope of the present invention.

### LIST OF REFERENCE NUMERALS

1 Main battery
2 Sub-battery module
2A Electricity supply relay circuit
2B Sub-battery
3 Main voltage detection circuit
4a, 4b, 4c Diode
5a, 5b, 5c Electricity supply wire
6a, 6b, 6c Load
7a, 7b, 7c, 71, 72, 73 Fuse
20 Control circuit
21, 22, 23 Switch
54 Electricity receiving wire
100 Vehicle
101 Engine room
102 Cabin
211 First terminal
212 Second terminal
213 Third terminal
214 Fourth terminal
215 Relay coil (Electric conduction control element)
P1, P2, P3 Control terminal

1. An electricity supply relay circuit for relaying electricity supplied from a sub-battery to a plurality of loads to which electricity is supplied from a main battery provided in a vehicle, the electricity supply relay circuit comprising:
a plurality of switches corresponding to the loads;
an electricity receiving wire connecting the switches to the sub-battery;
a plurality of electricity supply wires corresponding to the loads via which electricity is supplied from the switches to the corresponding loads; and
a control circuit that turns on the switches when a voltage of the main battery is lower than a predetermined first threshold.

2. The electricity supply relay circuit according to claim 1,
wherein the control circuit turns off the switches when a state of charging of the sub-battery becomes smaller than predetermined second thresholds for the corresponding loads.

3. The electricity supply relay circuit according to claim 1,
wherein the voltage of the main battery is detected by a main voltage detection circuit connected to the sub-battery via the electricity receiving wire.

4. The electricity supply relay circuit according to claim 1,
wherein the switches are each formed by a relay including:
a first terminal connected to the electricity receiving wire corresponding to the switch;
a second terminal connected to the electricity supply wire corresponding to the switch; and
an electric conduction control element that includes a third terminal connected to the first terminal of the switch and a fourth terminal connected to a control terminal of the control circuit, electric conduction between the first terminal and the second terminal in the switch being allowed as a result of an electric current flowing through the electric conduction control element,
wherein the control circuit controls turning-on/turning-off of the switches by controlling electric potentials of the control terminals, and supplies electricity from the sub-battery to the loads.

5. The electricity supply relay circuit according to claim 4, further comprising:
fuses provided between the switches and the electricity receiving wire,
wherein the control circuit detects whether or not the fuses have melted by detecting the electric potentials of the control terminals.

6. A sub-battery module comprising:
the electricity supply relay circuit according to claim 1; and
the sub-battery.

7. A power source system comprising:
the sub-battery module according to claim 6; and
the main battery.

8. The power source system according to claim 7,
wherein the main battery and the sub-battery module are provided at positions diagonally opposite to each other in the vehicle.
